(19) United States
(12) Patent Application Publication
(10) Pub. No.: US 2026/0268101 A1
(43) Pub. Date: Sep. 10, 2026

(54) Card with Combined Multi-Touch Sensing and NFC Sensing and Card Reading Device Thereof

(71) Applicant: EMERGING DISPLAY TECHNOLOGIES CORP., Kaohsiung City (TW)

(72) Inventors: Chih Hung LU, Hualien City (TW); YA-TING CHANG, Kaohsiung City (TW)

(21) Appl. No.: 19/332,422

(22) Filed: Sep. 18, 2025

(30) Foreign Application Priority Data
Mar. 6, 2025 (TW) 114108297

(51) Int. Cl. G06K 7/10; G06F 3/044

(52) U.S. Cl. CPC G06K 7/10336; G06F 3/044; G06F 2203/04104

(57) ABSTRACT

A card with combined multi-touch sensing and NFC sensing comprises a sensing layer substrate, a touch pad sensing area, a handheld touch sensing pad, and an NFC sensing area, wherein the handheld touch sensing pad is configured to be held by a user, and the NFC sensing area comprises an NFC tag chip and an NFC sensing coil for receiving or transmitting an NFC communication signal; a card reading device of combined multi-touch sensing and NFC sensing comprises a cover, a capacitive touch panel, and an NFC microcontroller chip, wherein the cover comprises an NFC card-reading coil connected to the NFC microcontroller chip to receive or transmit the NFC communication signal. Therefore, the card with combined multi-touch sensing and NFC sensing and the card reading device thereof can simultaneously perform multi-touch sensing and NFC sensing.

### CROSS REFERENCE TO RELATED APPLICATIONS

The present application claims priority to Taiwan application No. 114108297, filed on Mar. 6, 2025, the content of which is hereby incorporated by reference in its entirety.

### BACKGROUND OF THE INVENTION

### 1. Field of the Invention

The present invention relates to a card with a function of NFC (Near-Field Communication) sensing, especially a card with combined multi-touch sensing and NFC sensing and a card reading device thereof.

### 2. Description of the Related Art

NFC is a set of communication protocols that enables two electronic devices to wirelessly transmit digital information within a short distance of a few centimeters. In the present, technology of NFC contactless sensing has been widely applied in in our daily lives, such as an NFC transportation card, an NFC credit card, various payment applications on mobile phones, NFC access card, etc. Referring to FIG. 12, FIG. 12 presents a structure of a conventional NFC sensing card 70. The NFC sensing card 70 comprises a transparent upper surface layer 71, an upper printing layer 72, an inner layer 73, an NFC sensing layer 74, a lower printing layer 75, and a transparent lower surface layer 76, wherein the NFC sensing layer 74 is located in the middle of the structure and has an NFC circuit for near field communication, and the other layers are configured to protect the NFC circuit of the NFC sensing layer 74.

However, in some application scenarios, users must first hold the NFC card for NFC sensing and then operate a user-machine-interface (UMI) to select required items, which are not convenient for the users. Referring to FIGS. 13 and 14, FIGS. 13 and 14 present a control panel 80 of an elevator. A user is required to hold an NFC identification card 83 close to an NFC reader 82 in the control panel 80 to authenticate the user's identity (a first step), and then press a button 81 of a destined floor (a second step). That is, the user must complete the aforementioned two steps to control the elevator to reach the destined floor. Moreover, in some application scenarios, users must first operate the user-machine-interface (UMI) and then hold the NFC card for NFC sensing. Referring to FIGS. 15 and 16, FIGS. 15 and 16 present a vending machine 90. The user is first required to touch a graphic button of an option display panel 91 of the vending machine 90 (a first step), wherein the graphic button is corresponding to an item the user wants to purchase. Then, the user is required to hold an NFC payment card 93 close to an NFC reader 92 to pay (a second step). That is, the user must complete the aforementioned two steps to purchase the item.

A reason for the inconvenience of the aforementioned two-step operation is that NFC cards can only be used for identity authentication, payment, etc., but cannot be used for selection operations such as selecting options, selecting buttons, etc. Therefore, how to enable NFC card users to complete identity authentication and floor selection in one operation step, or how to complete item purchase and card payment in one step is a problem worth overcoming in the field of NFC card technology.

### SUMMARY OF THE INVENTION

In view of the shortcoming that the conventional NFC card mentioned above can only be used for identity authentication, payment, etc., but cannot be used for operation of option selecting, button selecting, etc., the present invention provides a card with combined multi-touch sensing and NFC sensing and a card reading device thereof. The card with combined multi-touch sensing and NFC sensing comprises:
a multi-touch and NFC sensing layer comprising:
a sensing layer substrate having a surface;
a touch pad sensing area disposed on a side of the surface of the sensing layer substrate;
a handheld touch sensing pad disposed on another side of the surface of the sensing layer substrate opposite to the touch pad sensing area; and
an NFC sensing area disposed on the surface of the sensing layer substrate and located between the handheld touch sensing pad and the touch pad sensing area;
wherein the handheld touch sensing pad is connected to the touch pad sensing area by a wire.

A first embodiment of the card reading device of combined multi-touch sensing and NFC sensing comprises:
a cover comprising a cover body and an NFC card-reading coil embedded in the cover body, wherein the NFC card-reading coil has two terminals and is wound at least one cycle along edges of the cover body, and the two terminals of the NFC card-reading coil are connected to the NFC microcontroller chip to receive or transmit an NFC communication signal;
a capacitive touch panel; and
an NFC microcontroller chip.

A second embodiment of the card reading device of combined multi-touch sensing and NFC sensing comprises:
a cover comprising a cover body and an NFC card-reading coil embedded in the cover body, wherein the NFC card-reading coil has two terminals and is wound at least one cycle along edges of the cover body, and the two terminals of the NFC card-reading coil are connected to the NFC microcontroller chip to receive or transmit an NFC communication signal;
a capacitive touch panel;
a display panel; and
an NFC microcontroller chip.

A third embodiment of the card reading device of combined multi-touch sensing and NFC sensing comprises:
an integrated substrate having an upper surface and a lower surface; and
an NFC microcontroller chip;
wherein an NFC integrated coil, a touch panel wiring area, and a capacitive touch sensing area are mounted on the upper surface of the integrated substrate, and an NFC integrated coil ground area and an ITO (indium tin oxide) shielding layer are mounted on the lower surface of the integrated substrate;
the NFC microcontroller chip is connected to the NFC integrated coil to receive or transmit an NFC communication signal.

The card with combined multi-touch sensing and NFC sensing and the card reading device thereof of the present invention can simultaneously perform multi-touch sensing and NFC sensing and appropriately combine operations of a card authentication system and a user-machine-interface (UMI) system. The present invention is for identity authentication, payment, etc. and operation of option selecting, button selecting, etc. Therefore, the present invention greatly improves conveniences of daily use for users; for example, a user is able to complete identity authentication and floor selection in one step, or complete item selection and card payment in one step.

### BRIEF DESCRIPTION OF THE DRAWINGS

FIG. 1 is a structural schematic diagram of an embodiment of a card with combined multi-touch sensing and NFC sensing of the present invention;

FIG. 2 is a circuit schematic diagram of a multi-touch and NFC sensing layer of an embodiment of the card with combined multi-touch sensing and NFC sensing of the present invention;

FIG. 3 is a structural schematic diagram of a handheld touch sensing pad of an embodiment of the card with combined multi-touch sensing and NFC sensing of the present invention;

FIG. 4 is a structural schematic diagram of a touch sensing pad of an embodiment of the card with combined multi-touch sensing and NFC sensing of the present invention;

FIG. 5 is a cross-sectional schematic diagram of a first embodiment of a card reading device of combined multi-touch sensing and NFC sensing of the present invention;

FIG. 6 is a structural schematic diagram of a cover of the card reading device of combined multi-touch sensing and NFC sensing of the present invention;

FIG. 7 is a schematic diagram of multi-touch sensing data read by the card reading device of combined multi-touch sensing and NFC sensing of the present invention;

FIG. 8 is a cross-sectional schematic diagram of a second embodiment of the card reading device of combined multi-touch sensing and NFC sensing of the present invention;

FIG. 9 is a cross-sectional schematic diagram of a third embodiment of the card reading device of combined multi-touch sensing and NFC sensing of the present invention;

FIG. 10 is a schematic diagram of a first application operating embodiment of the card with combined multi-touch sensing and NFC sensing and the card reading device thereof of the present invention;

FIG. 11 is a schematic diagram of a second application operating embodiment of the card with combined multi-touch sensing and NFC sensing and the card reading device thereof of the present invention;

FIG. 12 is a structural schematic diagram of a conventional NFC sensing card;

FIGS. 13 and 14 are schematic diagrams of two steps of operating an elevator via the conventional NFC sensing card; and

FIGS. 15 and 16 are schematic diagrams of two steps of operating a vending machine via the conventional NFC sensing card.

### DETAILED DESCRIPTION OF THE INVENTION

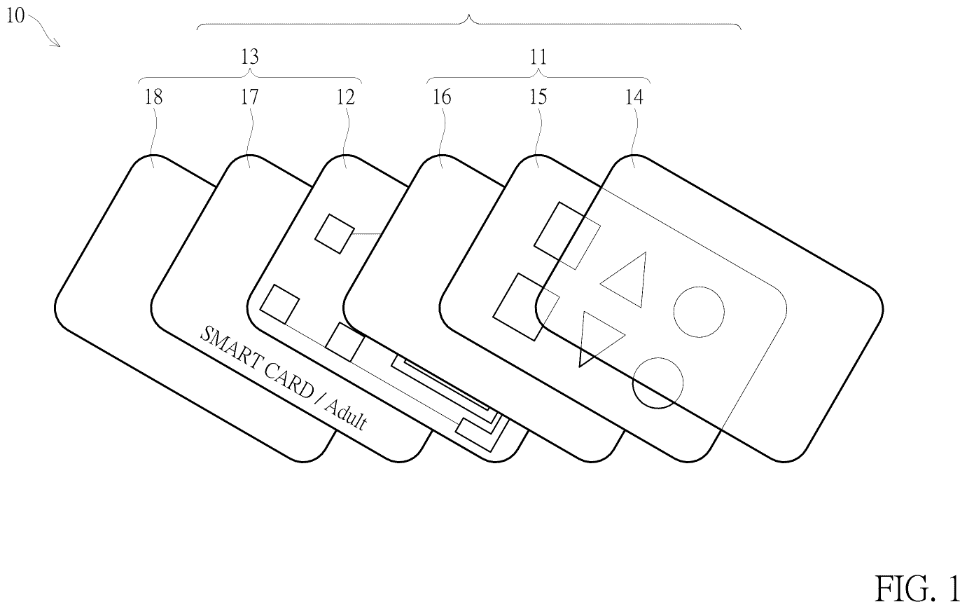

Referring to FIG. 1, a multi-touch and NFC sensing card 10 is an embodiment of the card with combined multi-touch sensing and NFC sensing of the present invention. The multi-touch and NFC sensing card 10 comprises an upper protecting layer 11, a multi-touch and NFC sensing layer 12, and a lower protecting layer 13, wherein the upper protecting layer 11 further comprises a transparent upper surface layer 14, an upper printing layer 15, and an inner layer 16 in order, and the lower protecting layer 13 further comprises a lower printing layer 17 and a transparent lower surface layer 18. For example, materials of the transparent upper surface layer 14 and the transparent lower surface layer 18 can be transparent impact-resistant polycarbonate (PC), and materials of the upper printing layer 15, the inner layer 16, and the lower printing layer 17 can be polyvinyl chloride (PVC), polyethylene terephthalate (PET), glycol-modified polyethylene terephthalate (PETG), or the combinations of PVC, PET, and PETG. Surfaces of the upper printing layer 15 and the lower printing layer 17 can be printed with various texts or patterns for dictation and for users to visually identify the multi-touch and NFC sensing card 10.

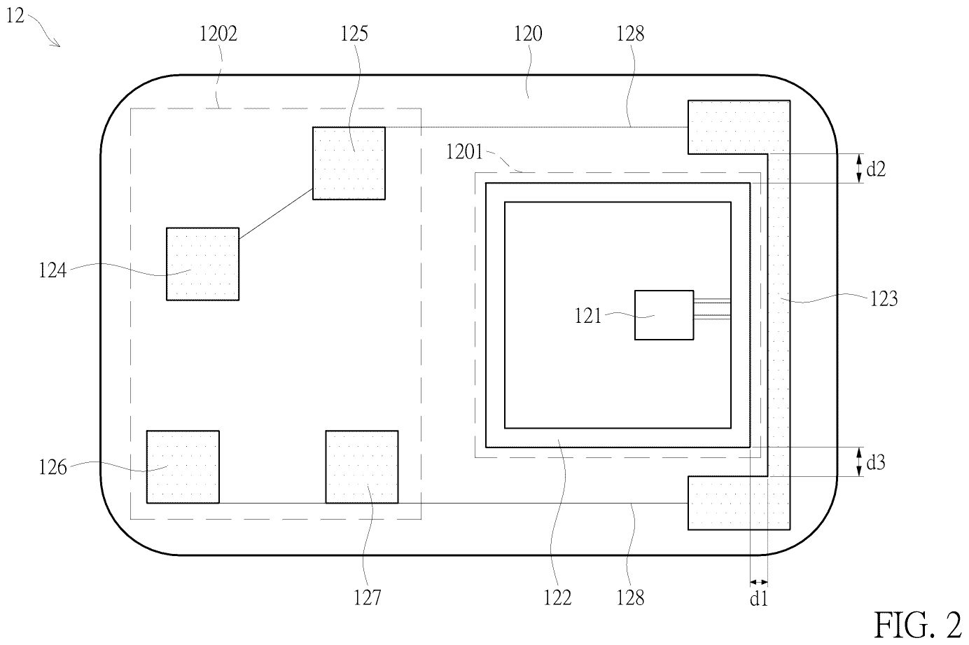

Referring to FIGS. 1 and 2, the multi-touch and NFC sensing layer 12 is actually a sensing layer substrate 120. A surface of the sensing layer substrate 120 is mounted with an NFC sensing area 1201, a touch pad sensing area 1202, and a handheld touch sensing pad 123. The multi-touch and NFC sensing layer 12 is mounted between the upper protecting layer 11 and the lower protecting layer 13 to protect the multi-touch and NFC sensing layer 12 from damages, wherein the touch pad sensing area 1202 is connected to the handheld touch sensing pad 123 by a wire 128.

In an embodiment, the handheld touch sensing pad 123 and the touch pad sensing area 1202 are disposed on opposite sides of the sensing layer substrate 120, and the NFC sensing area 1201 is disposed between the handheld touch sensing pad 123 and the touch pad sensing area 1202. When a user operates the multi-touch and NFC sensing card 10 for reading, the user may hold the handheld touch sensing pad 123 by the user's hand (fingers).

In an embodiment, an NFC tag chip 121 and an NFC sensing coil 122 are mounted in the NFC sensing area 2101, and the NFC tag chip 121 is connected to the NFC sensing coil 122 which is disposed along edges of the NFC sensing area 1201. The NFC tag chip 121 can therefore receive or transmit an NFC communication signal via the NFC sensing coil 122. For example, the NFC tag chip 121 can be an NTAG213 chip from NXP, and area of the NFC sensing area 1201 may be 31(millimeters)*31(millimeters). The present invention is not limited to foregoing examples.

In an embodiment, three sides of the handheld touch sensing pad 123 are adjacent and opposite to three sides of the NFC sensing coil 122 respectively to form three side pairs. Each of the three side pairs has a gap with a gap width of d1, d2, and d3, respectively. The gap widths of the three side pairs are greater than or equal to a threshold, respectively. For example, the threshold is equal to 1.1 mm(millimeters), such that the NFC sensing coil 122 and the handheld touch sensing pad 123 avoid interference effects caused by excessive capacitive coupling accordingly.

In an embodiment, the touch pad sensing area 1202 has a first touch sensing pad 124, a second touch sensing pad 125, a third touch sensing pad 126, and a fourth touch sensing pad 127. The first touch sensing pad 124 to the fourth touch sensing pad 127 are connected to the handheld touch sensing pad 123 by the wire 128.

In an embodiment, the handheld touch sensing pad 123, and the first touch sensing pad 124 to the fourth touch sensing pad 127 are each respectively a metal layer.

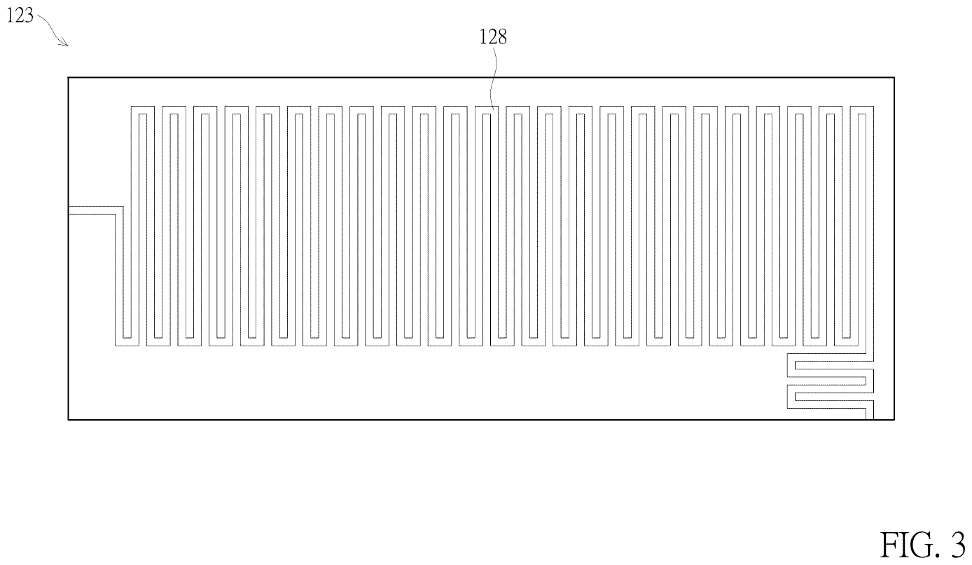

Referring to FIG. 3, in an embodiment, the handheld touch sensing pad 123 is formed by densely winding the wire 128, wherein a width of the wire 128 is 0.1 millimeters, and a winding pitch of the wire 128 is 0.1 millimeters. The present invention is not limited to the foregoing examples.

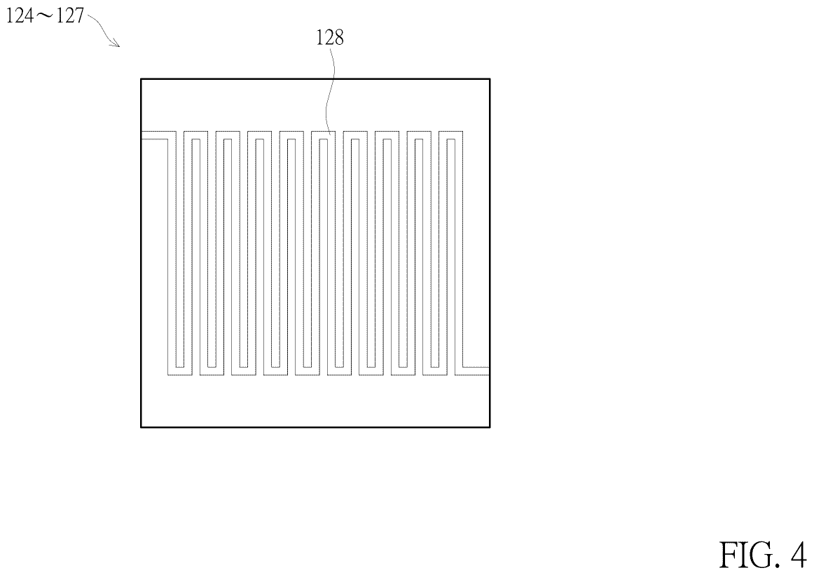

Referring to FIG. 4, in an embodiment, the first touch sensing pad 124 to the fourth touch sensing pad 127 are each respectively formed by densely winding the wire 128, wherein a width of the wire 128 is 0.1 millimeters, and a winding pitch of the wire 128 is 0.1 millimeters. The present invention is not limited to the foregoing examples.

Referring to FIGS. 2 to 4, in an embodiment, connections between the first touch sensing pad 124 to the fourth touch sensing pad 127, and connections between the handheld touch sensing pad 123 and the first touch sensing pad 124 to the fourth touch sensing pad 127 are formed by the wire 128.

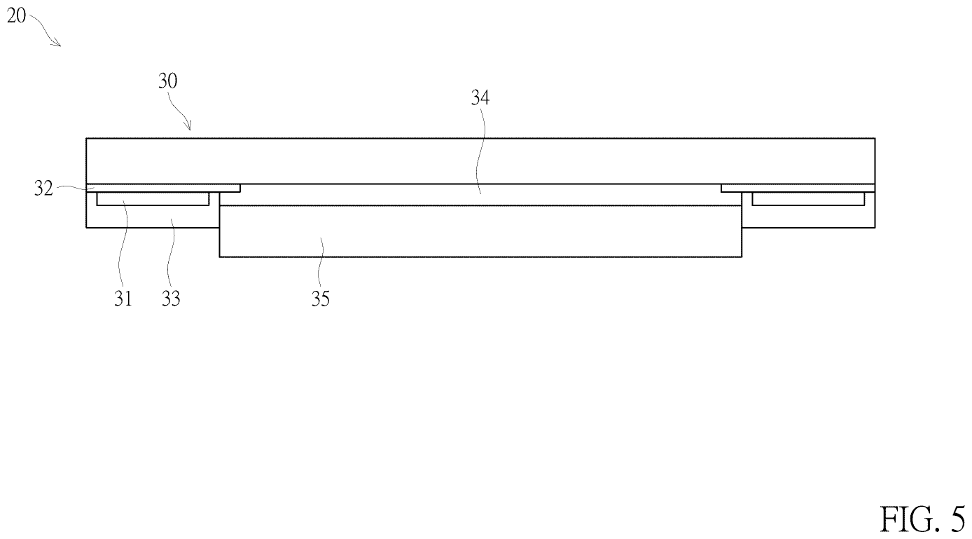

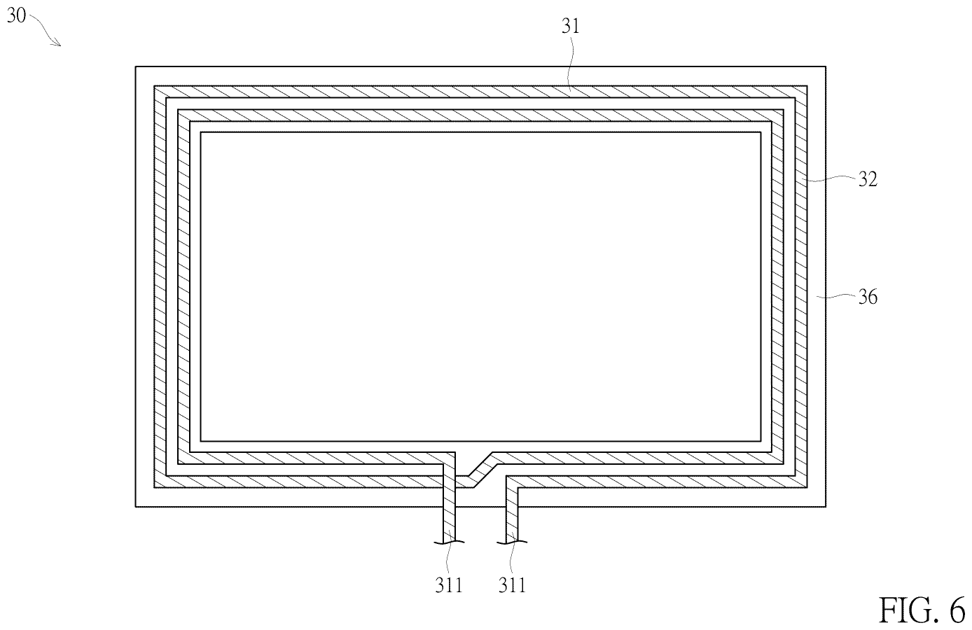

Referring to FIG. 5, a first card reading device 20 is a first embodiment of a card reading device of combined multi-touch sensing and NFC sensing of the present invention. The first card reading device 20 comprises a cover 30, a capacitive touch panel 35, and an NFC microcontroller chip (not shown in Figures). Referring to FIGS. 5 and 6, the cover 30 further comprises an NFC card-reading coil 31, a pair of connecting flexible boards 311, an ink layer 32, an insulating protective layer 33 (as shown in FIG. 5), and a cover body 36. The NFC card-reading coil 31 has two terminals and is wound at least one cycle along edges of the cover body 36, and the two terminals of the NFC card-reading coil 31 are connected to the NFC microcontroller chip via the pair of connecting flexible boards 311. The NFC microcontroller chip can thus transmit or receive the NFC communication signal by the NFC card-reading coil 31. The ink layer 32 is configured to cover an inner surface of the cover 30 to prevent the NFC card-reading coil 31 from being visible from an outer surface of the cover 30. Therefore, the cover 30 comprises an embedded NFC card-reading coil. Material of the cover body 36 can be glass or plastic. In an embodiment, an outer surface of the cover body 36 is printed patterns, such as multiple button selection areas.

As mentioned above, the insulating protective layer 33 is covered on the NFC card-reading coil 31 (as shown in FIG. 5) to protect the NFC card-reading coil 31. The capacitive touch panel 35 is mounted on the inner surface of the cover 30 (with the embedded NFC card-reading coil). Moreover, the capacitive touch panel 35 is attached and fixed to the inner surface of the cover 30 via an optical adhesive layer 34, wherein the optical adhesive can be an optical clear adhesive (OCA) or an optical clear resin (OCR). Therefore, the cover 30 (with the embedded NFC card-reading coil) and the NFC microcontroller chip can perform near field communication with the NFC tag chip 121 and the NFC sensing coil 122 of the multi-touch and NFC sensing card 10. That is, the NFC microcontroller chip determines whether to accept an NFC tag of the NFC tag ship 121. The capacitive touch panel 35 of the first card reading device 20 can perform multi-touch sensing with the first touch sensing pad 124 to the fourth touch sensing pad 127 of the multi-touch and NFC sensing card 10.

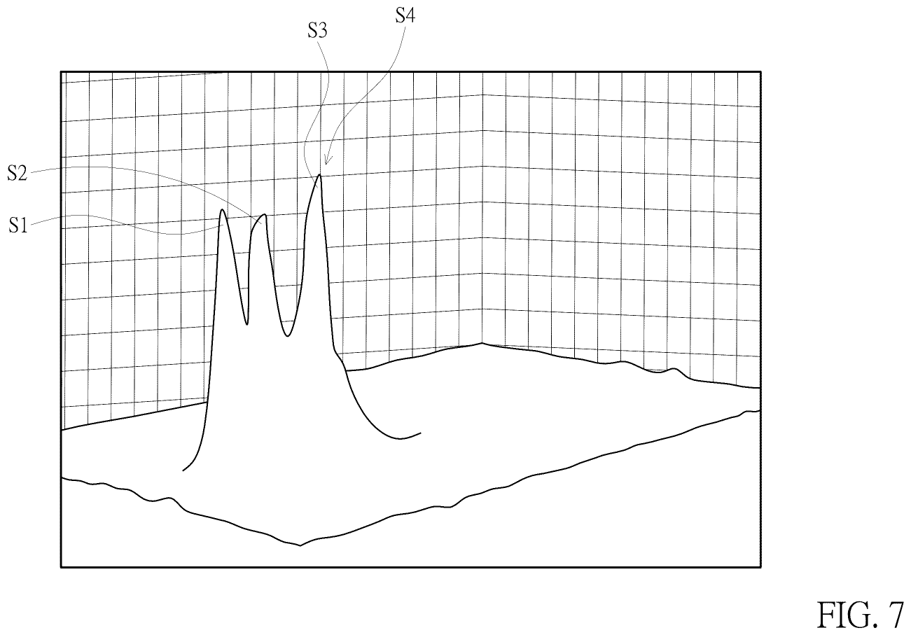

Referring to FIG. 7, in an embodiment, when the capacitive touch panel 35 of the first card reading device 20 can perform multi-touch sensing with the first touch sensing pad 124 to the fourth touch sensing pad 127 of the multi-touch and NFC sensing card 10, the capacitive touch panel 35 generates four touch signals S1 to S4 as shown in FIG. 7, wherein the touch signal S4 is less noticeable because the touch signal S4 is blocked by the touch signal S3. The four touch signals S1 to S4 correspond to four positions P1 to P4 on the capacitive touch panel 35 respectively, wherein the four positions P1 to P4 correspond to a multi-touch recognition pattern. Therefor, the capacitive touch panel is able to determine whether the multi-touch recognition pattern can be accepted.

The capacitive touch panel 35 computes a central position according to the four positions P1 to P4 (not shown in Figures). For example, coordinate of the central position can be an average value of coordinates of the four positions P1 to P4. Or, the coordinate of the central position can be a weighted average value of coordinates of the four positions P1 to P4, wherein a first weight value is a ratio of the signal strength of the first touch signal S1 to a sum of the signal strengths of the four touch signals S1 to S4, a second weight value is a ratio of the signal strength of the second touch signal S2 to the sum of the signal strengths of the four touch signals S1 to S4, a third weight value is a ratio of the signal strength of the third touch signal S3 to the sum of the signal strengths of the four touch signals S1 to S4, and a fourth weight value is a ratio of the signal strength of the fourth touch signal S4 to the sum of the signal strengths of the four touch signals S1 to S4. Therefore, the central position can be regarded as the position of the multi-touch recognition pattern on the capacitive touch panel 35.

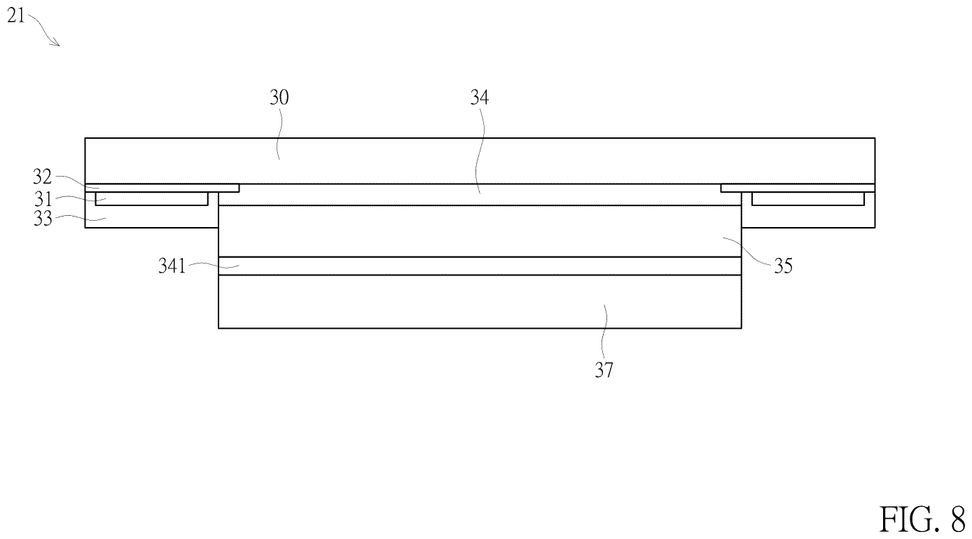

Referring to FIG. 8, a second card reading device 21 is a second embodiment of the card reading device of combined multi-touch sensing and NFC sensing of the present invention. Compared with the first card reading device 20, the second card reading device 21 further comprises a display panel 37 and an optical adhesive layer 341 for the display panel 37 to be attached to the capacitive touch panel 35. Therefore, the second card reading device 21 has a display function in addition to multi-touch sensing and NFC sensing. In the present embodiment, the material of the cover body 36 can be transparent glass or plastic, and the display panel 37 can display icons such as multiple button selection areas. The user thus can see images displayed on the display panel 37 through the cover body 36.

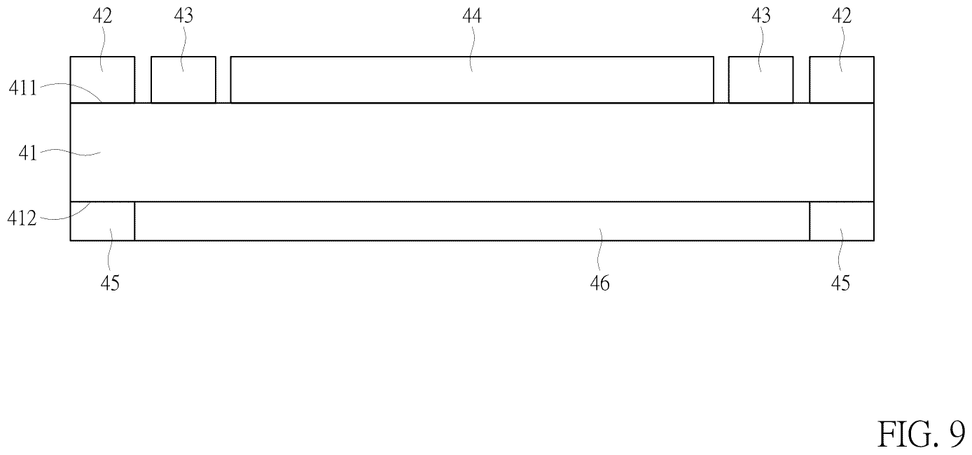

Referring to FIG. 9, a third card reading device 22 is a third embodiment of the card reading device of combined multi-touch sensing and NFC sensing of the present invention. Compared with the first card reading device 20, the third card reading device 22 integrates the functions of the cover 30 (with the embedded NFC card-reading coil) and the capacitive touch panel 35 into an integrated substrate 41. In detail, the third card reading device 22 comprises the integrated substrate 41, and an NFC integrated coil 42, a touch panel wiring area 43, a capacitive touch sensing area 44, an NFC integrated coil ground area 45, and an ITO (indium tin oxide) shielding layer 46 mounted on the integrated substrate 41, wherein the NFC integrated coil 42, the touch panel wiring area 43, and the capacitive touch sensing area 44 are mounted on an upper surface 411 of the integrated substrate 41, and the NFC integrated coil ground area 45 and the ITO shielding layer 46 are mounted on a lower surface 412 of the integrated substrate 41. The NFC integrated coil 42 is connected to the NFC microcontroller chip for receiving or transmitting the NFC communication signal. The NFC integrated coil 42 is disposed on the upper surface 411 along edges of the upper surface 411, the capacitive touch sensing area 44 is disposed on a central part of the upper surface 411, and the touch panel wiring area 43 is disposed between the NFC integrated coil 42 and the capacitive touch sensing area 44. The ITO shielding layer 46 is disposed on the central part of the lower surface 412, and a position of the ITO shielding layer 46 is corresponding to a position of the touch panel wiring area 43 and a position of the capacitive touch sensing area 44. The NFC integrated coil ground area 45 is wound along edges of the lower surface 412, and a position of the NFC integrated coil ground area 45 is corresponding to a position of the NFC integrated coil 42.

As mentioned above, in an embodiment, materials of the NFC integrated coil 42, the capacitive touch sensing area 44, and the NFC integrated coil ground area 45 can be indium tin oxide (ITO) or metal. The material of the touch panel wiring area 43 can be metal, and the material of the integrated substrate 41 can be glass or flexible material such as liquid crystal polymer (LCP), polyethylene terephthalate (PET), or polyimide (PI). The present invention is not limited to the foregoing examples.

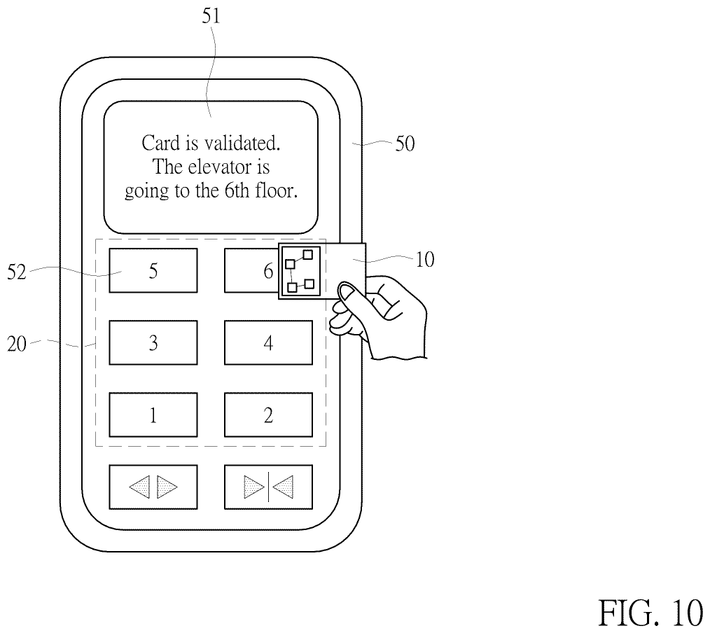

Referring to FIG. 10, FIG. 10 presents an application operating embodiment of the card with combined multi-touch sensing and NFC sensing and the card reading device thereof of the present invention, wherein an elevator control panel 50 of an elevator has the first card reading device 20, and the outer surface of the first card reading device 20 is printed with multiple button selection areas which are respectively corresponding to different floors. The user can hold the multi-touch and NFC sensing card 10 of the present invention close to the button selection area which is corresponding to the destined floor, such as a button selection area 52 with number “6”. When the first card reading device 20 determines that the NFC tag and the multi-touch recognition pattern of the multi-touch and NFC sensing card 10 sensed by the card reading device 20 are acceptable, and the central position of the multi-touch recognition pattern is within a range of the button selection area 52 with number “6”, the elevator control panel 50 controls a display 51 to display “Card is validated. The elevator is going to the 6^{th} floor.” and controls the elevator to go to the 6^{th} floor.

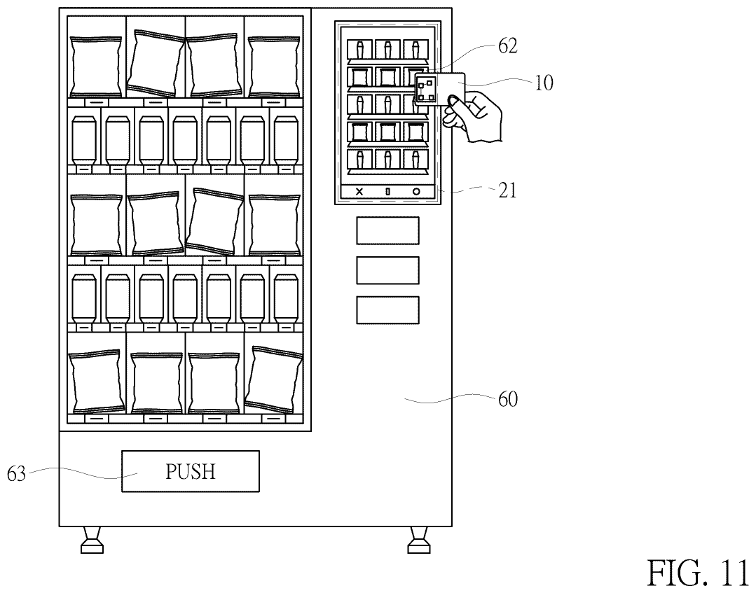

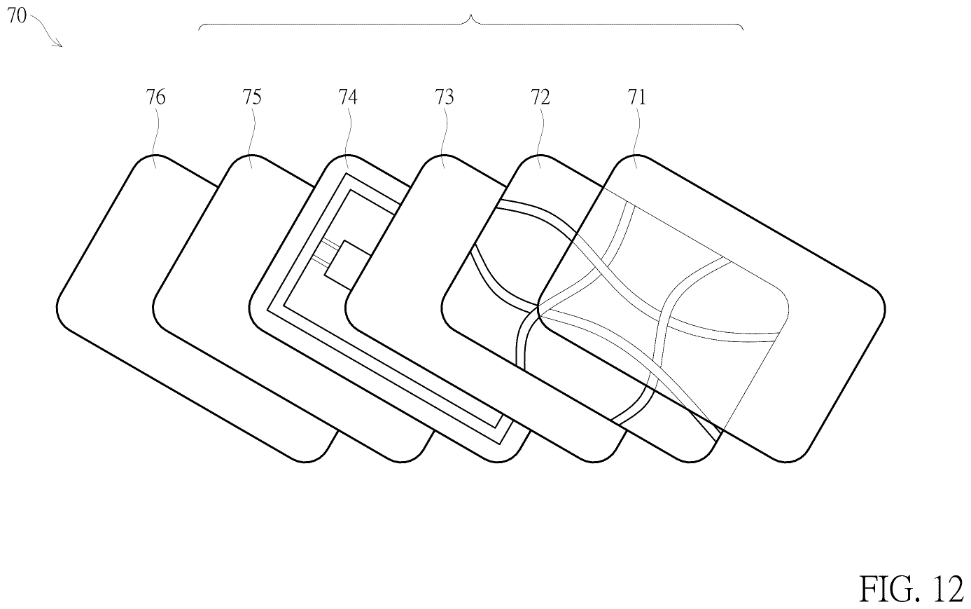

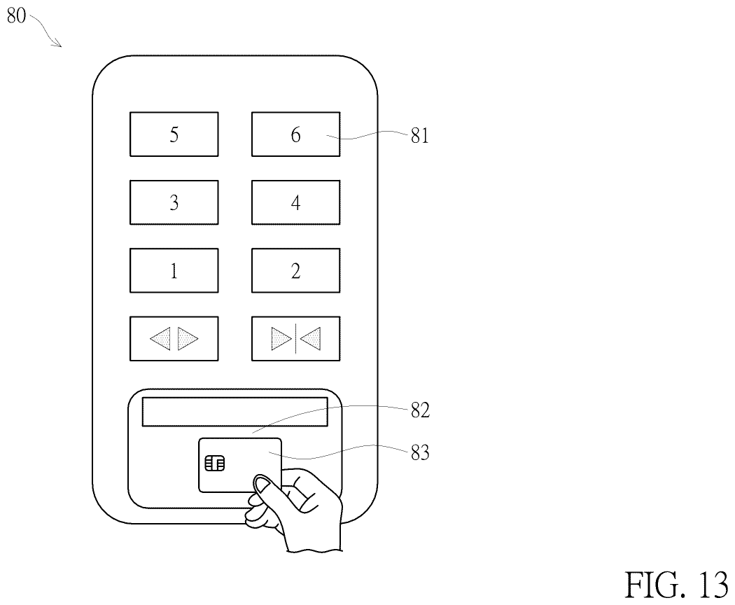

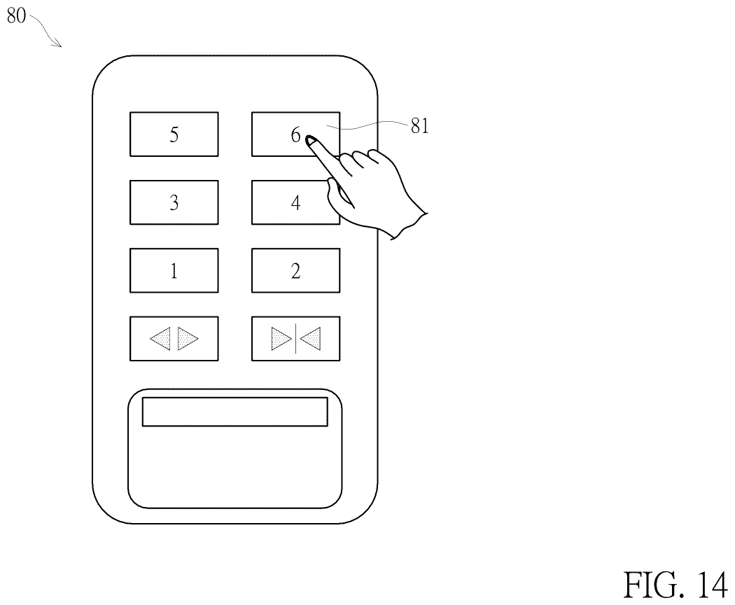

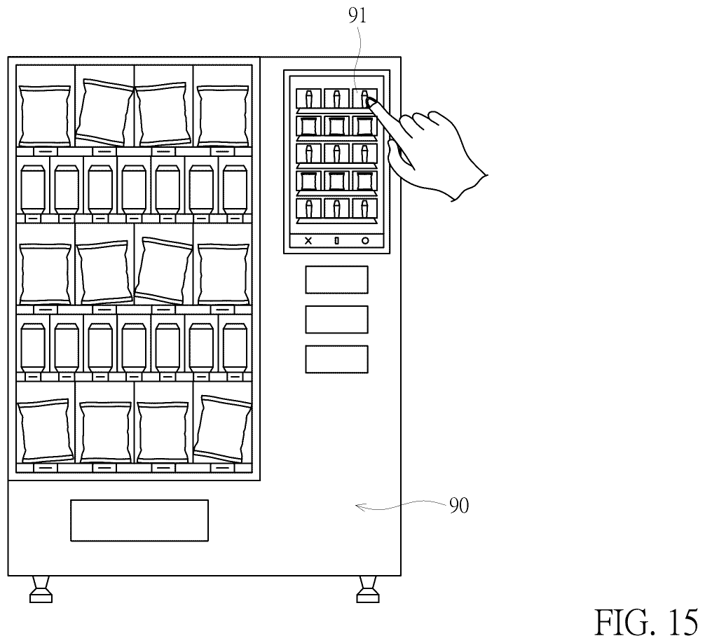

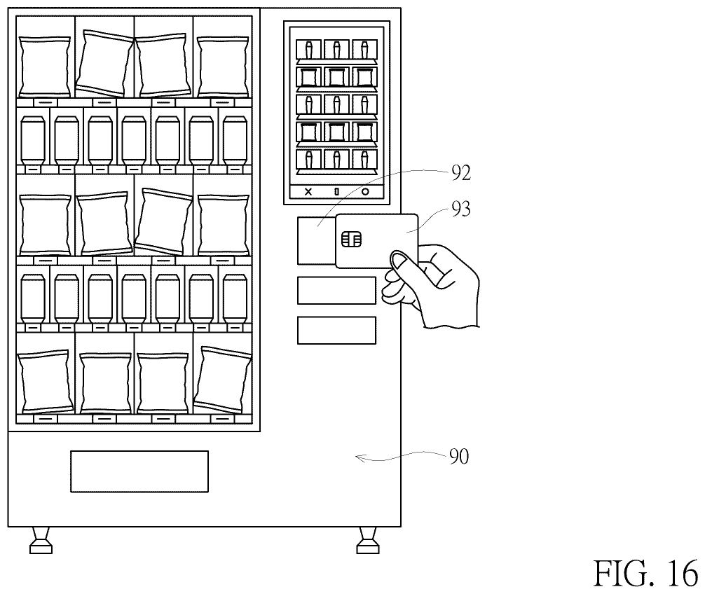

Referring to FIG. 11, FIG. 11 presents another application operating embodiment of the card with combined multi-touch sensing and NFC sensing and the card reading device thereof of the present invention, wherein a vending machine 60 has the second card reading device 21. The second card reading device 21 displays an option interface including multiple selection areas which are corresponding to multiple items. The user can hold the multi-touch and NFC sensing card 10 of the present invention close to the selection area which is corresponding to an item the user intends to purchase, such as a selection area 62 corresponding to an item of rice crackers. When the second card reading device 21 determines the NFC tag and multi-touch recognition pattern of the multi-touch and NFC sensing card 10 sensed by the card reading device 20 are acceptable, and the central position of the multi-touch recognition pattern is within a range of the selection area 62 corresponding to the item of rice crackers, the vending machine 60 can automatically operate to complete the payment of the multi-touch and NFC sensing card 10 and control the item of rice crackers in the vending machine 60 to drop into a pick-up box 63. The user thus can get the item of rice crackers from the pick-up box 63.

Please not that: when the user holds the multi-touch and NFC sensing card 10 close to the card reading device, the user's hand should touch the handheld touch sensing pad 123 (shown in FIG. 2) of the multi-touch and NFC sensing card 10, and align the touch pad sensing area 1202 of multi-touch and NFC sensing card 10 with an option area that the user intends to select in the first card reading device 20, the second card reading device 21, or the third card reading device 22 to prevent capacitive sensing in the option area from unexpected interference by the user's hand which affects the card-reading result.

What is claimed is:

1. A card with combined multi-touch sensing and NFC (Near-Field Communication) sensing, the card comprising:
a multi-touch and NFC sensing layer comprising:
a sensing layer substrate having a surface;
a touch pad sensing area disposed on a side of the surface of the sensing layer substrate;
a handheld touch sensing pad disposed on another side of the surface of the sensing layer substrate opposite to the touch pad sensing area; and
an NFC sensing area disposed on the surface of the sensing layer substrate and located between the handheld touch sensing pad and the touch pad sensing area;
wherein the handheld touch sensing pad is connected to the touch pad sensing area by a wire.

2. The card as claimed in claim 1 further comprising:
an upper protecting layer; and
a lower protecting layer;
wherein the multi-touch and NFC sensing layer is mounted between the upper protecting layer and the lower protecting layer.

3. The card as claimed in claim 1, wherein:
the NFC sensing area comprises an NFC tag chip and an NFC sensing coil; and
the NFC tag chip is connected to the NFC sensing coil to receive or transmit an NFC communication signal, and the NFC sensing coil is disposed along edges of the NFC sensing area.

4. The card as claimed in claim 3, wherein:
three sides of the handheld touch sensing pad are adjacent and opposite to three sides of the NFC sensing coil respectively to form three side pairs;
each side pair has a gap, and gap widths of the gaps of the three sides pairs are greater than or equal to a threshold, respectively.

5. The card as claimed in claim 4, wherein:
the threshold is greater than or equal to 1.1 millimeters.

6. The card as claimed in claim 1, wherein:
the touch pad sensing area comprises multiple touch sensing pads electrically connected to the handheld touch sensing pad by the wire.

7. The card as claimed in claim 6, wherein:
at least one of the multiple touch sensing pads is formed by a densely winded wire.

8. The card with combined multi-touch sensing and NFC sensing as claimed in claim 1, wherein:
the handheld touch sensing pad is formed by densely winding the wire.

9. A card reading device of combined multi-touch sensing and NFC sensing, the card reading device comprising:
a cover comprising a cover body and an NFC card-reading coil embedded in the cover body;
a capacitive touch panel; and
an NFC microcontroller chip;
wherein the NFC card-reading coil has two terminals and is wound at least one cycle along edges of the cover body, and the two terminals of the NFC card-reading coil are connected to the NFC microcontroller chip to receive or transmit an NFC communication signal.

10. The card reading device as claimed in claim 9, wherein:
the card reading device is configured to sense a multi-touch recognition pattern of multiple touch sensing pads of a touch pad sensing area of the card and an NFC tag of an NFC tag chip in an NFC sensing area of the card as claimed in claim 1.

11. The card reading device as claimed in claim 10, wherein:
the card reading device is configured to compute a central position of the multi-touch recognition pattern.

12. A card reading device of combined multi-touch sensing and NFC sensing, the card reading device comprising:
a cover comprising a cover body and an NFC card-reading coil embedded in the cover body;
a capacitive touch panel;
a display panel; and
an NFC microcontroller chip;
wherein the NFC card-reading coil has two terminals and is wound at least one cycle along edges of the cover body, and the two terminals of the NFC card-reading coil are connected to the NFC microcontroller chip to receive or transmit an NFC communication signal.

13. The card reading device as claimed in claim 12, wherein:
the card reading device is configured to sense a multi-touch recognition pattern of multiple touch sensing pads of a touch pad sensing area of the card and an NFC tag of an NFC tag chip in an NFC sensing area of the card as claimed in claim 1.

14. The card reading device as claimed in claim 13, wherein:
the card reading device is configured to compute a central position of the multi-touch recognition pattern.

15. A card reading device of combined multi-touch sensing and NFC sensing, the card reading device comprising:
an integrated substrate having an upper surface and a lower surface; and
an NFC microcontroller chip;
wherein an NFC integrated coil, a touch panel wiring area, and a capacitive touch sensing area are mounted on the upper surface of the integrated substrate, and an NFC integrated coil ground area and an ITO (indium tin oxide) shielding layer are mounted on the lower surface of the integrated substrate;
the NFC microcontroller chip is connected to the NFC integrated coil to receive or transmit an NFC communication signal.

16. The card reading device as claimed in claim 15, wherein:
the card reading device is configured to sense a multi-touch recognition pattern of multiple touch sensing pads of a touch pad sensing area of the card and an NFC tag of an NFC tag chip in an NFC sensing area of the card as claimed in claim 1.

17. The card reading device as claimed in claim 16, wherein:
the card reading device is configured to compute a central position of the multi-touch recognition pattern.

18. The card reading device as claimed in claim 15, wherein:
the NFC integrated coil is disposed on the upper surface of the integrated substrate along edges of the upper surface of the integrated substrate, the capacitive touch sensing area is disposed on a central part of the upper surface of the integrated substrate, and the touch panel wiring area is disposed between the NFC integrated coil and the capacitive touch sensing area;
the ITO shielding layer is disposed on the central part of the lower surface of the integrated substrate, and a position of the ITO shielding layer is corresponding to a position of the touch panel wiring area and a position of the capacitive touch sensing area;
the NFC integrated coil ground area is wound along edges of the lower surface of the integrated substrate, and a position of the NFC integrated coil ground area is corresponding to a position of the NFC integrated coil.

19. The card reading device as claimed in claim 18, wherein:
the card reading device is configured to sense a multi-touch recognition pattern of multiple touch sensing pads of a touch pad sensing area of the card and an NFC tag of an NFC tag chip in an NFC sensing area of the card as claimed in claim 1.

20. The card reading device as claimed in claim 19, wherein:
the card reading device is configured to compute a central position of the multi-touch recognition pattern.
